(19) United States
(12) Patent Application Publication
(10) Pub. No.: US 2010/0300240 A1
(43) Pub. Date: Dec. 2, 2010

(54) APPARATUS FOR GENERATING HYSTERESIS OF ELECTRONIC ACCELERATOR PEDAL

(75) Inventors: Donghwan KIM, Ulsan (KR); Yonghwan MO, Ulsan (KR)

Correspondence Address: LRK Patent Law Firm, 1952 Gallows Rd, Suite 200, Vienna, VA, 22182, US

(73) Assignee: DONGHEE INDUSTRIAL CO., LTD., Ulsan (KR)

(21) Appl. No.: 12/579,057

(22) Filed: Oct. 14, 2009

(30) Foreign Application Priority Data
May 26, 2009 (KR) 10-2009-0045815

(51) Int. Cl. G05G 1/44; G05G 1/30

(52) U.S. Cl. 74/513

(57) ABSTRACT

The present invention relates to an apparatus for generating hysteresis equipped in an electronic accelerator pedal for a vehicle, which makes it possible not only to reduce the manufacturing cost, weight, and fuel consumption by reducing the number of parts of an apparatus for generating hysteresis, but achieve a compact configuration by reducing the size of a housing. Further, it is possible to facilitate assembly, reduce assembly time, and improve productivity.

### BACKGROUND OF THE INVENTION

1. Field of the Invention

The present invention relates to an apparatus for generating hysteresis equipped in an electronic accelerator pedal for a vehicle.

2. Description of the Related Art

In general, the accelerator pedal of vehicles is a device for adjusting the intake amount of gas mixture in gasoline engines and the revolution number of the engine by adjusting the injection amount of fuel in diesel engines.

Accelerator pedals widely used at present are mechanical accelerator pedals that adjust the combustion amount by opening/closing a throttle valve in a carburetor through an accelerator cable.

However, the mechanical accelerator pedals have a defect of an error of the operational range of a throttle valve and an injection pump, when the tension of the accelerator cable is changed by environmental changes or deterioration.

In order to prevent the defect, recently, electronic accelerator pedals that electronically control the engine and the peripheral devices have been developed, in which the pedal arm rotates about a hinge shaft when a driver presses down the pedal pad, and as the pedal arm rotates, a sensor lever connected with the pedal arm rotates.

As the sensor lever rotates, a sensor attached to a pedal arm housing detects changes in output by the rotation of the sensor lever and transmits an electric signal to a throttle control unit, and then the throttle control unit transmits a control signal to activate an actuator such that the throttle valve is opened/closed, and as a result, the combustion amount is adjusted.

The electronic accelerator pedals are configured not to use an accelerator cable, such that it possible to ensure a space without influence of changes in tension of the cable. Therefore, it is possible to provide improved operability for the driver and reduce the fatigue, and it is also possible to reduce fuel consumption by improving fuel efficiency.

Meanwhile, the electronic accelerator pedals commonly include an apparatus for generating hysteresis that makes is possible to largely reduce the driver's fatigue due to operating the pedal pad by making different the pedal effort when the driver presses down the pedal pad and the force applied to the driver's foot through the pedal pad when the driver takes the foot off the pedal pad.

### SUMMARY OF THE INVENTION

The present invention addresses the problem described above and it is an apparatus for generating hysteresis of an electronic accelerator pedal for a vehicle that includes: a pedal arm that is rotatably connected to a housing and integrally has a spring seat mounting portion at one end in the housing and a rotational center protrusion composed of partial protrusions divided into at least one part by a cutting groove; a plurality of fitting grooves that is arranged around the rotational center protrusion on the upper surface of the spring seat mounting portion; a spring seat that is fitted on the rotational center protrusion to be rotatable on the spring seat mounting portion and has a housing contact protrusion that is in contact with the inner wall of the housing, on the outer circumference; a plurality of spring seat protrusions that integrally protrudes from the bottom of the spring seat and is inserted in the fitting grooves, respectively; and an inner spring and an outer spring of which ends are supported by the upper surface of the housing and the other ends are supported by the spring seat.

According to the present invention, it is possible not only to reduce the manufacturing cost, weight, and fuel consumption by reducing the number of parts of an apparatus for generating hysteresis equipped in an electronic accelerator pedal, but achieve a compact configuration by reducing the size of a housing. Further, it is possible to facilitate assembly, reduce assembly time, and improve productivity.

### BRIEF DESCRIPTION OF THE DRAWING

FIG. 1 is a perspective view of an accelerator pedal equipped with an apparatus for generating hysteresis according to the present invention;

FIG. 2 is a side view of the accelerator pedal with a housing cover removed in FIG. 1; and

FIGS. 3 and 5 are views for illustrating the parts of the apparatus for generating hysteresis according to the present invention.

### DETAILED DESCRIPTION OF THE PREFERRED EMBODIMENTS

Hereinafter, exemplary embodiments of the present invention will be described in detail with reference to the accompanying drawings.

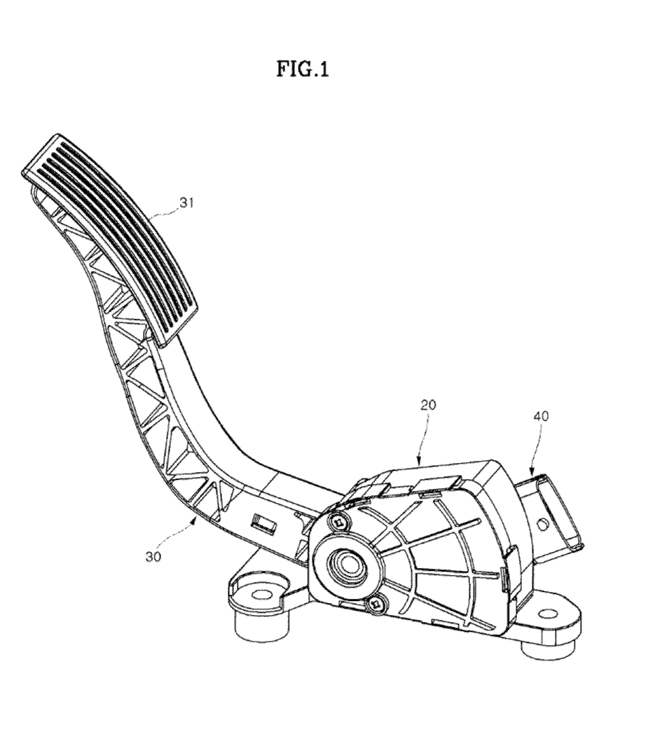

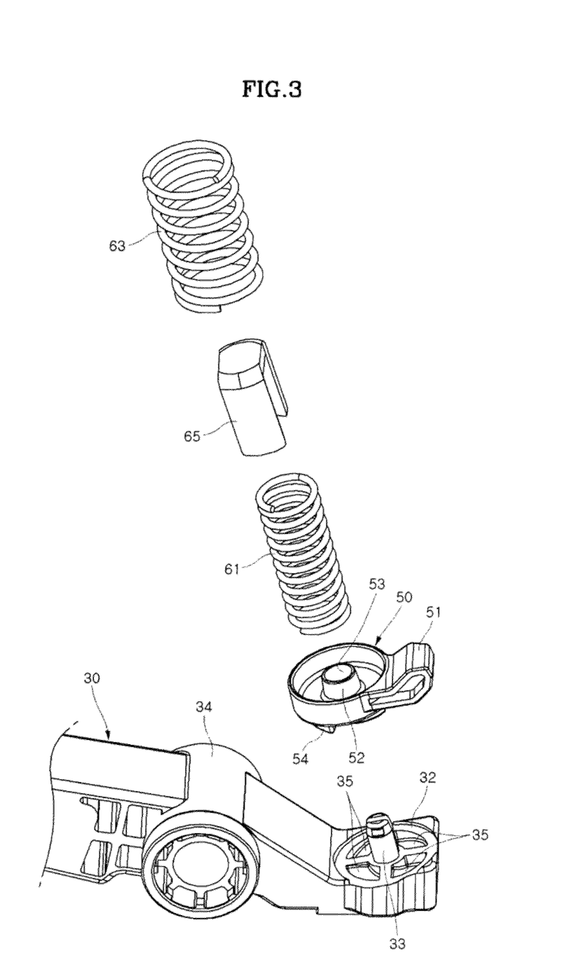

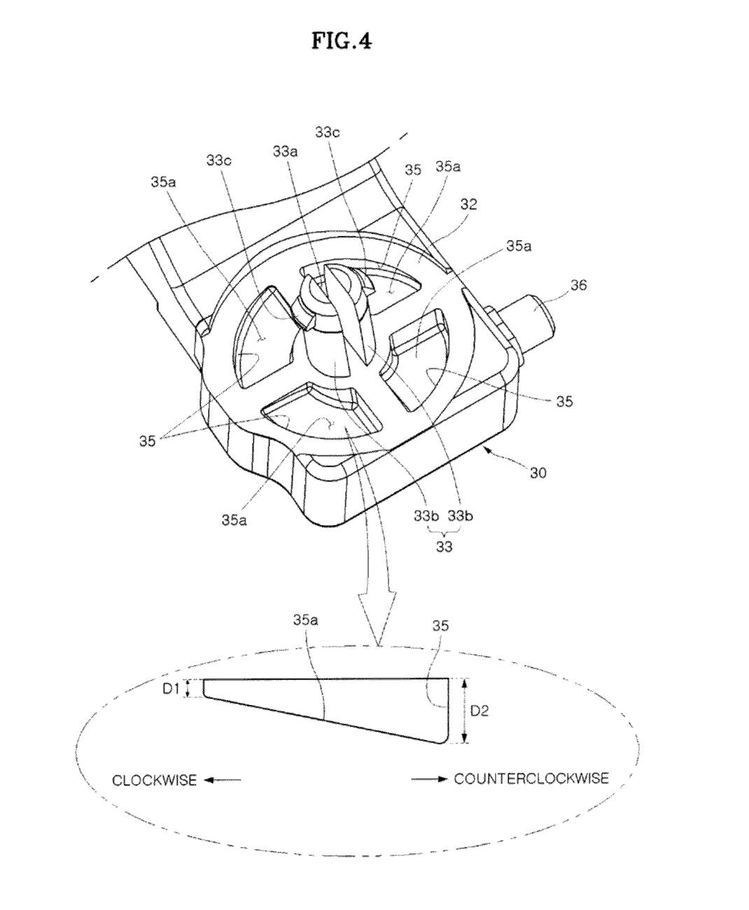

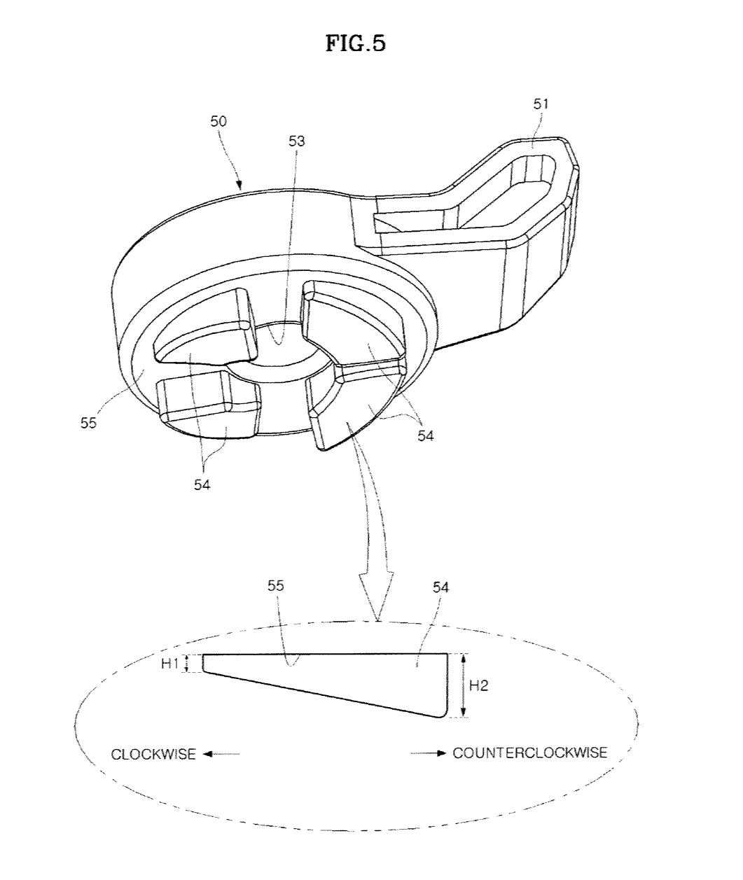

An electronic accelerator pedal assembly for a vehicle equipped with an apparatus for generating hysteresis, as shown in FIGS. 1 to 5, includes a housing 20 that is fixed to the dash panel under the driver's seat, a pedal arm 30 that is pressed down by the driver's foot, and a sensor 40 that is attached to one side of the housing 20 and activated when the pedal arm 30 rotates.

A pedal pad 31 that is pressed down by the driver's foot is integrally formed at one end of the pedal arm 30, and a spring seat mounting portion 32 and a rotational center protrusion 33 are integrally formed at the other end inside housing 20.

The pedal arm 30 is positioned with a cylinder portion 34 fitted on a hinge shaft 21 of the housing 30, such that when the driver presses down the pedal pad 31, the pedal arm 30 rotates about the hinge shaft 21.

A plurality of fitting grooves 35 is arranged around the rotational center protrusion 33 on the upper surface of the spring seat mounting portion 32, which are formed in arc shapes having the same size along the circumference of the rotational center protrusion 33.

Further, the bottom 35a of the fitting groove 35 formed in an arc shape is inclined with the depth increasing clockwise or counterclockwise (D1→D2).

The rotational center protrusion 33 protrudes upward from the center of the spring seat mounting portion 32 and is composed of the partial protrusions 33b divided at least two parts by a longitudinal cutting groove 33a.

Further, a connecting protrusion 33c having a triangular cross section is integrally formed at the upper outer circumference of each partial protrusion 33b.

The spring seat mounting portion 32 is fitted on the rotational center portion 33 for a spring seat 50 to stable rotate.

A housing contact protrusion 51 that contacts with the inner wall 22 of the housing 20 is formed on the outer circumference of the spring seat 50, a guide protrusion 52 protrudes upward from the center of the spring seat 50, and a protrusion hole 53 through which the rotational center protrusion 33 passes is formed in the guide protrusion 52.

Accordingly, when the rotational center protrusion 33 of the pedal arm 30 is fitted in the protrusion hole 53 of the spring seat 50, the partial protrusions 33b of the rotational center protrusion 33 pass through the protrusion hole 53 while elastically contracting, and then the partial protrusions 33b contracting return to the initial positions after the connecting protrusion 33c completely passes through the protrusion hole 53.

Therefore, the bottom of the connecting protrusion 33c is locked to the upper surface of the guide protrusion 52, such that the spring seat 50 cannot be detached from the rotational center protrusion 33 of the pedal arm 30.

Further, the spring seat 50 is combined with the pedal arm 30 on the spring seat mount portion 32, such that it is rotated clockwise or counterclockwise about the rotational center protrusion 33 by an external force.

On the other hand, a plurality of the spring seat protrusions 54 that is inserted in the fitting grooves 35 of the pedal arm 30 is integrally formed on the bottom 55 of the spring seat 50. The spring seat protrusions 54 are formed of arc-shaped protrusions having the same size along the circumference of the protrusion hole 53 to correspond to the fitting grooves 35 formed in arc shapes and arranged around the protrusion hole 53.

Further, the spring seat protrusion 54 formed in an arc shape is inclined with the height from the bottom 55 of the spring seat 50 increasing clockwise or counterclockwise (H1→H2).

The reason that the bottom 35a of the fitting groove 35 and the bottom of the spring seat protrusion 54 are inclined clockwise or counterclockwise is for the pedal arm 30 to smoothly rotate about the hinge shaft 21 when a driver presses down the pedal arm 30. Further, this is for generating hysteresis while the spring seat 50 smoothly rotates clockwise or counterclockwise about the rotational center protrusions 33, when the pedal arm 30 rotates.

If the bottom 35a of the fitting groove 35 and the bottom of the spring seat protrusion 54 are flat plane without inclination, the spring seat protrusion 54 is just fitted in the fitting groove 35, such that the spring seat 50 cannot rotate about the rotational center protrusion 33.

As described above, when the spring seat 50 cannot rotate and the housing contact protrusion 51 of spring seat 50 is in contact with the inner wall 22 of the housing 20, the housing contact protrusion 51 is stuck on the inner wall 22 of the housing 20 when the driver presses down the pedal arm 30, such that the pedal arm 30 cannot rotate about the hinge shaft 21.

That is, as the pedal arm 30 cannot rotate about the hinge shaft 21, not only it cannot function as an accelerator pedal, but it cannot generate hysteresis that the present invention addresses.

Therefore, the present invention inclines the bottom 35a of the fitting groove 35 and the bottom of the spring seat protrusion 54 to achieve smooth rotation of the pedal arm 30 and generation of hysteresis.

Further, the apparatus for generating hysteresis according to the present invention includes an inner spring 61 and an outer spring 63 of which the upper ends are supported by the spring locking protrusion 23 disposed on the upper inner surface of the housing 20 and the lower ends are supported by the spring seat 50.

The inner spring 61 and outer spring 63 may be formed of one spring making the same elastic force.

A spring pad 65 is disposed between the inner spring 61 and the outer spring 63 to prevent interference and noise between the inner spring 61 and the outer spring 63.

On the other hand, a lever connecting protrusion 36 integrally protrudes from a side of the spring seat mounting portion 32 of pedal arm 30, and the lever connecting protrusion 36 is connected with a sensor lever (not shown) of the sensor 40 attached to a side of the housing 20, through the side of the housing 20.

Accordingly, as the pedal arm 30 rotates, the lever connecting protrusion 36 and the sensor lever rotate, and as the sensor lever rotates, the sensor 40 attached to the housing 20 detects changes in output by the rotation of the sensor lever and transmits an electric signal to the throttle control unit, and then the throttle control unit transmits a control signal for activating the actuator to open/close the throttle valve, thereby adjusting the amount of combustion.

The operation of the present invention is described hereafter.

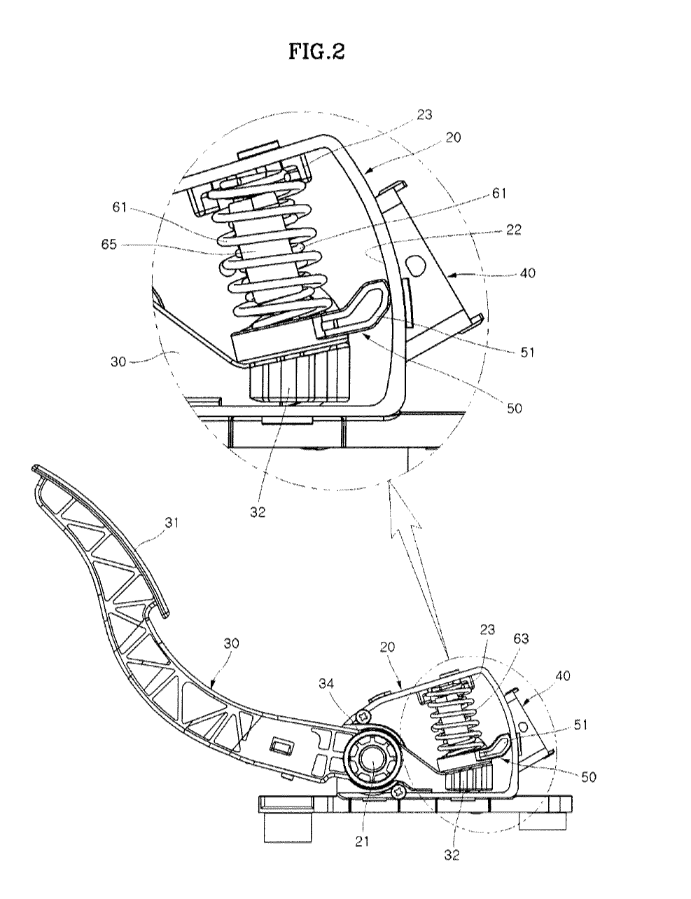

When a driver presses down the pedal pad 31 of pedal arm 30 positioned as in FIG. 2, the pedal arm 30 rotates counterclockwise about the hinge shaft 21, the inner spring 61 and the outer spring 63 contract, the sensor 40 transmits an electric signal to the throttle control unit in response to the amount of rotation of the pedal arm 30, and the throttle control unit transmits a control signal for activating the actuator to open/close the throttle valve, thereby adjusting the amount of combustion.

When the pedal pad 31 is released, the pedal arm 30 that has rotated counterclockwise is rotated clockwise by the return force of the inner spring 61 and the outer spring 63 to the initial position shown in FIG. 2, and stands by the next operation.

Meanwhile, the spring seat 50 rotates clockwise or counterclockwise about the rotational center protrusion 33 on the spring seat mounting portion 32, when the driver presses down pedal pad 31 and the pedal arm 30 rotates counterclockwise.

The reason that the spring seat 50 rotates is because the bottoms 35a of the fitting grooves 35 and the bottom of the spring seat protrusions 54 are inclined, and as the spring seat 50 rotates, the pedal arm 30 can smoothly rotate about the hinge shaft 21.

The housing contact protrusion 51 of the spring seat 50 is always in contact with the inner wall 22 of the housing 20, regardless of the rotation of the spring seat 50.

Therefore, a force larger than the sum of the elastic force of the inner spring 61, the elastic force of the outer spring 63, and the friction force of the housing contact protrusion 51 is required for the driver to press down the pedal pad 31.

However, when the pedal pad 31 pressed down is released, the force applied to the driver's foot from the pedal pad 31 is relatively reduced less than that applied by the driver pressing down the pedal pad 31, by the friction force of the housing contact protrusion 51.

Therefore, the accelerator pedal according to an embodiment of the present invention can generate hysteresis, such that the fatigue of the driver operating the pedal pad 31 is largely reduced.

The accelerator pedal according to an embodiment of the present invention as described above not only can generate hysteresis, but reduce the manufacturing cost, weight, and fuel consumption by reducing the number of parts, because the apparatus for generating hysteresis includes the pedal arm 30, the spring seat 50, the inner spring 61, and the outer spring 63. Further, it is possible to achieve a compact configuration by reducing the size of the housing 20.

Further, the present invention can largely facilitate assembly, reduce assembly time, and improve productivity, because the spring seat 50 is simply fitted on the rotational center protrusion 33 in one-touch way.

What is claimed is:

1. An apparatus for generating hysteresis of an electronic accelerator pedal for a vehicle, comprising:
a pedal arm that is rotatably connected to a housing and integrally has a spring seat mounting portion at one end in the housing and a rotational center protrusion composed of partial protrusions divided into at least one part by a cutting groove;
a plurality of fitting grooves that is arranged around the rotational center protrusion on the upper surface of the spring seat mounting portion;
a spring seat that is fitted on the rotational center protrusion to be rotatable on the spring seat mounting portion and has a housing contact protrusion that is in contact with the inner wall of the housing, on the outer circumference;
a plurality of spring seat protrusions that integrally protrudes from the bottom of the spring seat and is inserted in the fitting grooves, respectively; and
an inner spring and an outer spring of which ends are supported by the upper surface of the housing and the other ends are supported by the spring seat.

2. The apparatus for generating hysteresis of an electronic accelerator pedal for a vehicle as defined in claim 1, wherein a connecting protrusion having a triangular cross section is integrally formed at the upper outer circumference of each of the partial protrusions.

3. The apparatus for generating hysteresis of an electronic accelerator pedal for a vehicle as defined in claim 2, wherein a guide protrusion protrudes upward at the center of the spring seat, and a protrusion hole through which the rotational center protrusion passes is formed in the guide protrusion.

4. The apparatus for generating hysteresis of an electronic accelerator pedal for a vehicle as defined in claim 3, wherein the connecting protrusion is locked to the upper surface of the guide protrusion, through the protrusion hole.

5. The apparatus for generating hysteresis of an electronic accelerator pedal for a vehicle as defined in claim 4, wherein the fitting grooves are formed in an arc shape having the same size along the circumference of the rotational center protrusion.

6. The apparatus for generating hysteresis of an electronic accelerator pedal for a vehicle as defined in claim 5, wherein the bottom of the fitting groove formed in an arc shape is inclined with the depth increasing clockwise or counterclockwise.

7. The apparatus for generating hysteresis of an electronic accelerator pedal for a vehicle as defined in claim 5, wherein the spring seat protrusions are formed of arc-shaped protrusions having the same size along the circumference of the protrusion hole to correspond to the fitting grooves 35 formed in arc shapes and arranged around the protrusion hole.

8. The apparatus for generating hysteresis of an electronic accelerator pedal for a vehicle as defined in claim 7, wherein the spring seat protrusion formed in an arc shape is inclined with the height from the bottom of the spring seat increasing clockwise or counterclockwise.
